(19) United States
(12) Patent Application Publication
(10) Pub. No.: US 2014/0086803 A1
(43) Pub. Date: Mar. 27, 2014

(54) NOX REDUCTION

(71) Applicant: INTERNATIONAL ENGINE INTELLECTUAL PROPERTY COMPAN, Lisle, IL (US)

(72) Inventors: Carlos Luis Cattani, Aurora, IL (US); Michael Uchanski, Chicago, IL (US); Rogelio Rodiguez, Plainfield, IL (US); Dileep Khadilkar, Naperville, IL (US); Nishant Singh, Carol Stream, IL (US); Joao P. Silva, Naperville, IL (US); Bradley Jay Adelman, Chicago, IL (US); Silpa Mandarapu, Lombard, IL (US); Shyam Santhanam, Aurora, IL (US)

(73) Assignee: International Engine Intellectual Property Company, LLC, Lisle, IL (US)

(21) Appl. No.: 13/629,242

(22) Filed: Sep. 27, 2012

(51) Int. Cl. B01D 53/94

(52) U.S. Cl. 422/170

(57) ABSTRACT

A system for improving NOₓ reduction by incorporating an upstream treatment housing having a dual functionality catalyst that includes a diesel oxidation catalyst and a three-way catalyst, and which is positioned upstream of a main exhaust gas treatment system. The upstream treatment housing is positioned in relative close proximity to an exhaust turbine to prevent or minimize a reduction in exhaust gas temperature as the exhaust gas travels between the outlet of the turbine and the upstream treatment housing. By preventing such a reduction in exhaust gas temperature, the three way catalyst in the upstream treatment housing may operate at exhaust gas temperatures higher than those in main exhaust gas treatment system, which may allow for NOₓ conversion in the upstream treatment housing during certain cold operating or ambient conditions that is not typically attained in the main treatment system during such conditions.

### BACKGROUND

The amount of nitrogen oxides (NOₓ) exhausted from a diesel engine is typically dependent on the air-to-fuel ratio used to run the engine, along with several other factors, including, for example, combustion temperatures and the amount of oxygen present in the cylinder(s) during combustion events. Engines that operate solely under steady-state conditions are typically run using a lean burn mixture having a high air-to-fuel ratio. Desired torque, fuel economy and containable NOₓ emissions can be achieved through combustion optimization. However, during transient events, such as sudden changes in the load on the engine, achieving NOx containment through combustion optimization becomes challenging.

### BRIEF SUMMARY

An aspect of an illustrated embodiment is an exhaust system for the treatment of an exhaust gas generated during the operation of a diesel engine. The exhaust system includes an upstream treatment housing having a dual functionality catalyst comprising a three way catalyst and a diesel oxidation catalyst. The three way catalyst of the dual functionality catalyst has a formulation configured for the reduction of nitrogen oxides in the exhaust gas when the diesel engine is operating in stoichiometric or rich exhaust conditions. The diesel oxidation catalyst of the dual functionality catalyst is configured to oxidize hydrocarbons and carbon monoxide in the exhaust gas when the diesel engine is operating under lean exhaust conditions. The system also includes a main exhaust gas treatment system positioned downstream of the upstream treatment housing. The main exhaust gas treatment system has at least one of the following: (1) a diesel oxidation catalyst configured for the oxidation of hydrocarbons in the exhaust gas; and/or (2) a three-way catalyst formulation for the reduction of nitrogen oxides in the exhaust gas.

Another aspect of an illustrated embodiment is an exhaust system for the treatment of an exhaust gas generated during the operation of a diesel engine that includes an upstream treatment housing that has a dual functionality catalyst comprising a three-way catalyst and a diesel oxidation catalyst. The three way catalyst has a formulation configured for the reduction of nitrogen oxides in the exhaust gas when the diesel engine is operating in stoichiometric or rich exhaust conditions. The diesel oxidation catalyst of the dual functionality catalyst is configured to oxidize hydrocarbons and carbon monoxide in the exhaust gas when the diesel engine is operating under lean exhaust conditions. The exhaust system also includes a main exhaust gas treatment system positioned downstream of the upstream treatment housing. The main exhaust gas treatment system has a second dual functionality catalyst comprising: (1) a diesel oxidation catalyst configured for the oxidation of hydrocarbons and carbon monoxide present in the exhaust gas when the engine is operating under lean exhaust conditions; and (2) a three-way catalyst formulation configured for the reduction of nitrogen oxides when the diesel engine is operating in stoichiometric or rich exhaust conditions.

Another aspect of an illustrated embodiment is an exhaust system for the treatment of an exhaust gas generated during the operation of a diesel engine that includes a turbine having an inlet and an outlet, the exhaust gas exiting the outlet at a first temperature. The exhaust system also includes an upstream treatment housing operably connected to the outlet of the turbine. The upstream treatment housing has a first dual functionality catalyst comprising a first three way catalyst and a first diesel oxidation catalyst. The first three way catalyst having a formulation configured for the reduction of nitrogen oxides in the exhaust gas. The first diesel oxidation catalyst is configured to oxidize hydrocarbons and carbon monoxide in the exhaust gas. The upstream treatment housing is positioned in the exhaust system to receive exhaust gas at a second temperature that is within at least approximately 5 degrees Celsius of the first temperature. The exhaust gas treatment system also includes a main exhaust gas treatment system positioned downstream of the upstream treatment housing. The main exhaust gas treatment system has a second dual functionality catalyst comprising: (1) a second diesel oxidation catalyst configured to oxidize hydrocarbons and carbon monoxide in the exhaust gas; and (2) a second three-way catalyst formulation configured for the reduction of nitrogen oxides in the exhaust gas.

### BRIEF DESCRIPTION OF SEVERAL VIEWS OF THE DRAWINGS

FIG. 1 illustrates a diesel engine system that includes an upstream treatment housing positioned upstream of a main exhaust gas after-treatment system that includes a DOC housing and a diesel particulate filter (DPF).

FIG. 2 illustrates a diesel engine system that includes an upstream treatment housing positioned upstream of a main exhaust gas after-treatment system that includes a TWC housing and a DPF.

FIG. 3 illustrates a diesel engine system that includes an upstream treatment housing positioned upstream of a main exhaust gas after-treatment system that has a TWC housing.

### DETAILED DESCRIPTION

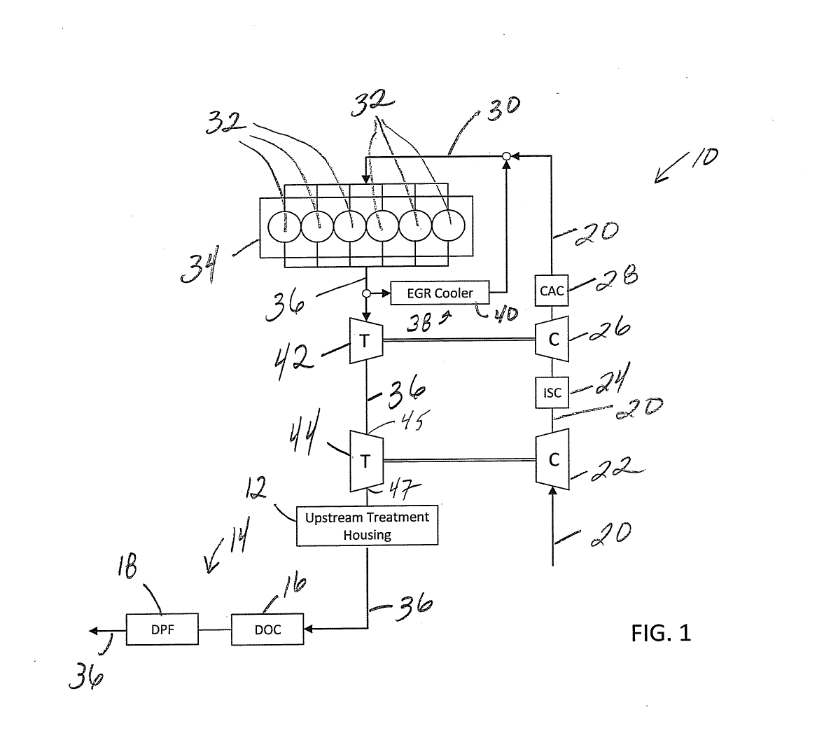

FIGS. 1-3 illustrate a diesel engine system 10 that includes an upstream treatment housing 12 positioned upstream of a main exhaust gas after-treatment system 14. As shown, air for use in the operation of the engine system 10, such as for use during the internal combustion process, may flow along an intake line 20 that includes various hoses and/or tubes. For example, air passes along a first portion of the intake line 20 and into a low pressure compressor 22 before flowing along a second portion of the intake line 20 to the interstage cooler 24. The air then flows through a high pressure compressor 26 and high pressure charged air cooler 28 before flowing through another portion of the intake line 20 to an intake manifold 30.

The air may flow through the intake manifold 30 and to cylinders 32 of the engine 34, where the air may be used in a combustion event(s) that is used to displace the pistons of the engine 34, thereby transmitting the force of the combustion event(s) into mechanical power that is used to drive the drivetrain of the associate vehicle. The resulting hot exhaust gas produced by the combustion event(s) may flow out of the cylinders 32 and engine 34 through an exhaust port(s) and along an exhaust line 36.

At least a portion of the hot exhaust gas from the engine 34 may be diverted from the exhaust line 36 and to an exhaust gas recirculation (EGR) system 38. The EGR system 38 is configured to recirculate the diverted exhaust gas back to the intake manifold 30. However, before the EGR system 38 recirculates exhaust gas, the exhaust gas is typically cooled by an EGR cooler 40 or heat exchanger. A coolant, such as antifreeze mixtures or non-aqueous solutions, among others, typically circulates through the EGR cooler 40. According to some designs, the coolant and/or the heated exhaust gases flow through tubes, a jacket, or other forms of conduits in the EGR cooler 40. The EGR cooler 40 may be configured so that heated exhaust gases flow around and/or over tubes containing flowing coolant, or vice versa, causing heat from the exhaust gas to be transferred to the coolant. The EGR cooler 40 may also include fins that assist with the transfer of heat from the exhaust gas to the coolant. After exiting the EGR cooler 40, the cooled exhaust gas is delivered to the intake manifold 30, thereby allowing the cooled exhaust gas to enter into the cylinders 32 with the air that was delivered to the intake manifold 30 through the intake line 20.

Exhaust gas that is not diverted to the EGR system 38 may continue to flow along the exhaust line 36 and be delivered to a high pressure turbine 42. The exhaust gas, and the heat entrained therein, may then at least assist in driving the high pressure turbine 42. Power generated by the high pressure turbine 42 may at least in part be used to power or drive the high pressure compressor 26.

Exhaust gas exiting the high pressure turbine 42 may then flow along the exhaust line 36 to an inlet 45 of a low pressure turbine 44. The low pressure turbine 44 may also be configured to be driven by the exhaust gas, and the heat entrained therein. Additionally, operation of the low pressure turbine 44 may be used to power or drive the low pressure air compressor 22. Although FIGS. 1-3 illustrate high and low pressure turbines 42, 44, according to certain embodiments, a single turbine or more than two turbines may be employed.

According to the embodiment shown in FIG. 1, exhaust gas exiting the outlet 47 of the low pressure turbine 44 passes through the exhaust line 36 and into the upstream treatment housing 12. The exhaust line 36 may operably connect the outlet 47 of the low pressure turbine 44 to the upstream treatment housing 12, such as, for example, through the exhaust line 36 and associated connectors or fasteners, including, for example, a clamp(s), ring(s), and/or threaded connection(s), among others.

The upstream treatment housing 12 includes a TWC formulation that is used to reduce the quantity of NOₓ in the exhaust gas. Such a TWC formulation may include chemical elements such as, for example, platinum, palladium, and/or rhodium, and various alkali, alkaline earth, and/or rare earth oxides. According to certain embodiments, the upstream treatment housing 12 may be coated with a dual functionality catalyst that includes the TWC formulation as part of a diesel oxidation catalyst (DOC). Thus, a single formulation in the upstream housing, namely the formulation of the dual functionality catalyst, may provide the benefits of both a TWC and/or DOC, depending on the operating conditions of the engine, and, more specifically, the conditions of the exhaust gas. According to such embodiments, during normal lean conditions, the dual functionality catalyst in the upstream treatment housing 12 may serve as an oxidation catalyst for oxidizing hydrocarbons and carbon monoxide to water and carbon dioxide. Operation of the engine during lean exhaust conditions may occur when, for example, the engine is operating under a traditional mode where there may be excess of O₂ present in the exhaust, such as relatively high air-to-fuel ratios. Such operations would include when the engine is operating under cruise control or operation, decelerations, or small rates of increase in high power demand. During engine usage, with the exception of occasional transient events, the engine usually is operating at under lean exhaust conditions, which facilitate the dual functionality catalyst to operate at as a DOC. The DOC of the dual functionality catalyst is configured for chemically converting pollutants in the exhaust stream under lean exhaust conditions. For example, the DOC of the dual functionality catalyst may contain palladium and platinum which serve as catalysts to oxidize hydrocarbons and carbon monoxide into carbon dioxide and water in the following reactions:

CO+½O₂→CO₂; and

[HC]+O₂→CO₂+H₂O.

According to certain embodiments, the dual functionality catalyst may require the possible addition of an oxygen storage component (OSC) and Rhodium. The dual functionality catalyst may also include components commonly found in DOC formulations, such as, for example, platinum (Pt) and/or palladium (Pd) on a high surface area alumina and catalyst stabilizers, such as, for example, BaSO₄, that may minimize PGM sintering at high temperatures (>500° C.).

The TWC, on the other hand, operates optimally at or near lambda=1. At these conditions, the TWC oxidizes hydrocarbons and carbon monoxide while simultaneously reducing NOₓ to nitrogen. The reaction occurs via dissociative adsorption of NO onto the metal surface to create adsorbed N and O atoms ([N]ads and [O]ads). The adsorbed N atom will combine with another nitrogen atom on the surface and form nitrogen gas. The adsorbed O atom reacts with hydrocarbons, carbon monoxide and/or hydrogen to form carbon dioxide and water and regenerate the metal surface where NO can adsorb.

NO→[N]ads+[O]ads

2[N]ads→N₂

CO+[O]ads→CO₂; and

[HC]+[O]ads→CO₂+H₂O.

The presence of the TWC formulation as part of the DOC of the dual functionality catalyst in the upstream treatment housing 12 allows for both the treatment of hydrocarbon and carbon monoxide by the DOC while a diesel engine 34 runs primarily lean of stoichiometry as well as NOx reduction by the TWC during rich excursions along with the potential for accompanying NH₃ formation. Rich or stoichiometric exhaust conditions may occur when the diesel engine is required to output high power over a short period of time, such as events including, for example, rapid acceleration. The addition of the upstream treatment housing 12, and the TWC contained therein, upstream of the main exhaust treatment system 14 also provides for additional catalyst volume (up to 15% of the main catalyst volume) with minimal packaging issues observed with a main or full-sized catalyst, such as the DOC or TWC housings 16, 46 of the main exhaust treatment system 14.

Additionally, according to certain embodiments, the upstream treatment housing 12 is in relative close proximity, such as, for example, between 6 to 12 inches, to the low pressure turbine 14 so as to prevent or minimize a decrease in the temperature of the exhaust gas, such as, for example, a temperature loss no greater than around 5° Celsius, as the exhaust gas passes from the low pressure turbine 44 to the upstream treatment housing 12. Thus, the temperature of the exhaust gas entering the upstream treatment housing 12 may be approximately the same as the temperature of the exhaust gas exiting the low pressure turbine 44. By generally maintaining the of temperature exhaust gas, the exhaust gas may arrive at the upstream treatment housing 12 at a temperature necessary for the TWC in the upstream treatment housing 12 to convert/reduce appreciable quantities of NOₓ in the exhaust gas. Further, by preventing or minimizing a drop in the temperature of the exhaust gas between the low pressure turbine 44 and the upstream treatment housing 12, the exhaust gas in the upstream treatment housing 12 may have a sufficiently high temperature for the conversion/reduction of NOₓ under cold engine or cold surrounding ambient conditions. Moreover, the temperature of the exhaust gas entering the upstream treatment housing 12 may be sufficient for the conversion/reduction of NOₓ during transient drive cycles despite the temperature of main exhaust gas treatment system 14, such as the DOC 16, being too low to exhibit appreciable conversion/reduction of NOₓ.

Further, the presence of the DOC in the upstream treatment housing 12 may also assist during active filter regenerations by serving as a mixing device to homogenize fuel that has been injected into the exhaust gas. Moreover, the DOC in the upstream treatment housing 12 may be used to create an exothermic reaction across components of the main exhaust treatment system 14, such as the DOC and/or TWC housings 16, 46, for burning stored soot on a filter in the main exhaust gas treatment system, such as soot on a diesel particulate filter (DPF) 18.

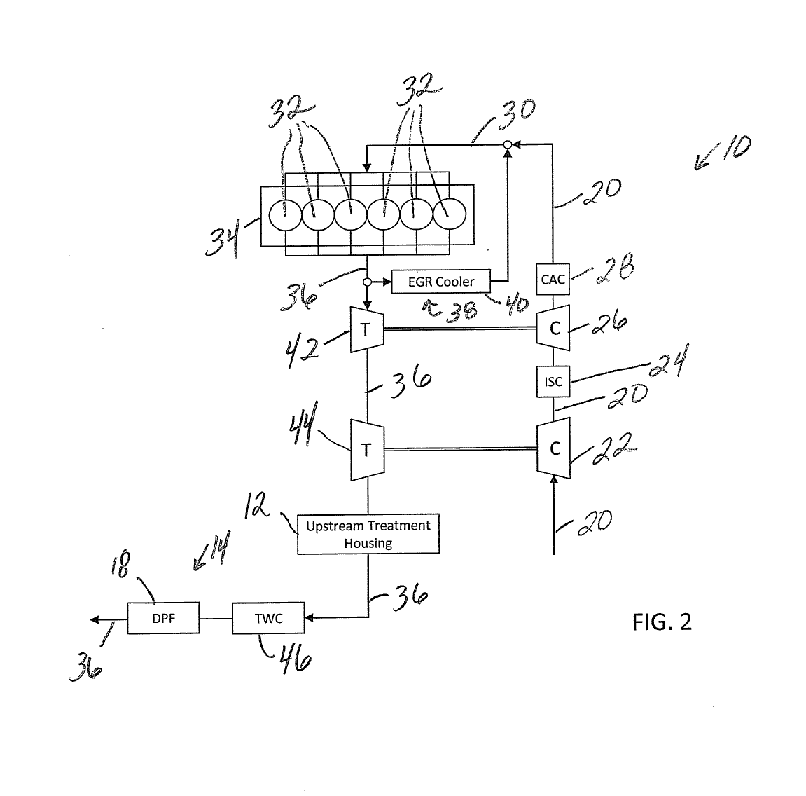

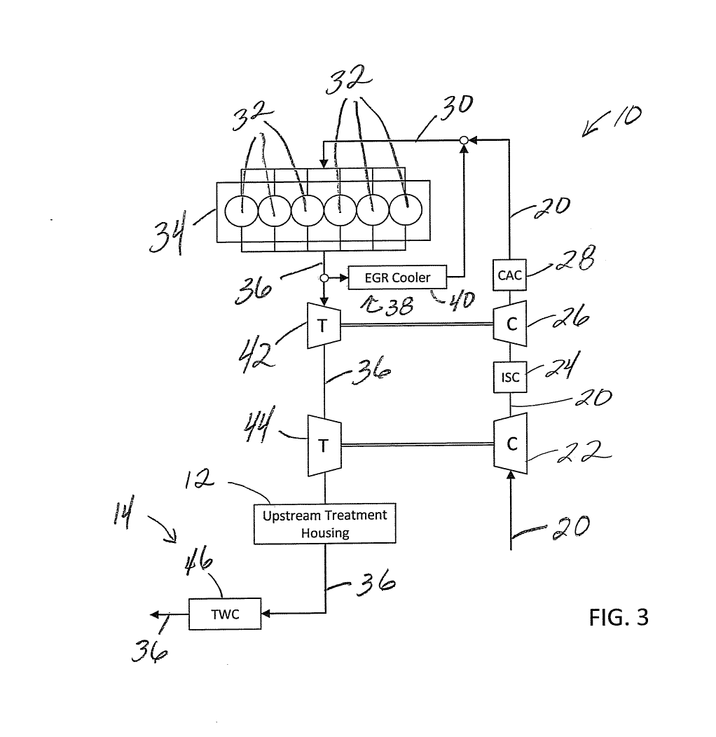

The exhaust gas exiting the upstream treatment housing 12 may then flow to the main exhaust treatment system 14. For example, according to certain embodiments, the exhaust gas exiting the upstream treatment housing 12 may flow through approximately at least 2 feet of a portion of the exhaust line 36 before reaching the main exhaust treatment system. The length of the exhaust line 36 between the upstream treatment housing 12 and the main exhaust treatment system 14 however may vary, and may be greater than or less than 2 feet. The main exhaust treatment system 14 may include a number of different components. For example, referencing FIGS. 2 and 3, the main exhaust treatment system 14 may include a TWC housing 46 that also includes a TWC formulation. The TWC formulation of the TWC housing 46 may be the same or different than the TWC formulation in the upstream treatment housing 12. Further, the quantity of the TWC in the TWC housing 46 may be larger, the same, or less than the quantity of TWC in the upstream treatment housing 12. Typically, however, the quantity of the TWC in the TWC housing 46 is larger than the quantity of TWC in the upstream treatment housing 12. Additionally, according to certain embodiments, the TWC housing 46 may include a second dual functionality catalyst that includes a catalyst formulation that has a single catalyst having a TWC formulation and a DOC formulation. The formulation of the second dual functionality of the TWC housing 46 may be the same or different than that of the dual functionality catalyst in the upstream treatment housing 12. Additionally, the second dual functionality catalyst of the TWC housing 46 may have a different platinum-group metal load, or different ratios of platinum metals than the dual functionality catalyst of the upstream treatment housing 12.

As shown in FIG. 2, the main exhaust treatment system 14 may also include a DPF 18 that may be configured to at least remove particulate matter, such as soot, from the exhaust gas. Referencing FIG. 1, rather than a TWC housing 46, the main exhaust treatment system 14 may include a DOC housing 16. Typically, the DOC housing 16 has a formulation that is different than the TWC formulation contained alone or as part of the dual functionality catalyst in the upstream treatment housing 12. Additionally, the quantity of DOC contained in the DOC housing 16 may be larger, the same, or less than the quantity of DOC in the dual functionality catalyst in the upstream treatment housing 12. However, typically, the quantity of DOC contained in the DOC housing 16 is larger than the quantity of DOC in the dual functionality catalyst in the upstream treatment housing 12.

1. An exhaust system for the treatment of an exhaust gas generated during the operation of a diesel engine, the exhaust system comprising:
an upstream treatment housing having a dual functionality catalyst comprising a three way catalyst and a diesel oxidation catalyst, the three way catalyst of the dual functionality catalyst having a formulation configured for the reduction of nitrogen oxides in the exhaust gas when the diesel engine is operating in stoichiometric or rich exhaust conditions, the diesel oxidation catalyst of the dual functionality catalyst configured to oxidize hydrocarbons and carbon monoxide in the exhaust gas when the diesel engine is operating under lean exhaust conditions; and
a main exhaust gas treatment system positioned downstream of the upstream treatment housing, the main exhaust gas treatment system having at least one of the following: (1) a diesel oxidation catalyst configured for the oxidation of hydrocarbons in the exhaust gas; and/or (2) a three way catalyst formulation for the reduction of nitrogen oxides in the exhaust gas.

2. The exhaust system gas treatment system of claim 1, wherein the diesel oxidation catalyst and three way catalyst formulation of the main exhaust gas treatment system are part of a second dual functionality catalyst.

3. The exhaust system of claim 1, wherein the quantity of the three-way catalyst of the dual functionality catalyst is smaller than the quantity of the three-way catalyst of main exhaust gas treatment system.

4. The exhaust system of claim 2, wherein the upstream treatment housing is positioned in close proximity to the outlet of a turbine to prevent a loss in an exhaust gas temperature as the exhaust gas passes from the outlet of the turbine to an inlet of the upstream treatment housing.

5. The exhaust system of claim 3 wherein the exhaust gas exiting the outlet of the turbine has a first temperature and the exhaust gas entering the inlet of the upstream treatment housing has a second temperature, and wherein the inlet of the upstream treatment housing is positioned in proximity to the outlet of the turbine so that the first temperature is no greater than 5 degrees Celsius larger than the second temperature during normal engine operating conditions.

6. The exhaust system of claim 3, wherein the main exhaust gas system includes a diesel particulate filter.

7. An exhaust system for the treatment of an exhaust gas generated during the operation of a diesel engine, the exhaust system comprising:
an upstream treatment housing having a first dual functionality catalyst comprising a three-way catalyst and a diesel oxidation catalyst, the three way catalyst having a formulation configured for the reduction of nitrogen oxides in the exhaust gas when the diesel engine is operating in stoichiometric or rich exhaust conditions, the diesel oxidation catalyst of the dual functionality catalyst configured to oxidize hydrocarbons and carbon monoxide in the exhaust gas when the diesel engine is operating under lean exhaust conditions; and
a main exhaust gas treatment system positioned downstream of the upstream treatment housing, the main exhaust gas treatment system having a second dual functionality catalyst comprising: (1) diesel oxidation catalyst configured for the oxidation of hydrocarbons and carbon monoxide present in the exhaust gas when the engine is operating under lean exhaust conditions; and (2) a three-way catalyst formulation configured for the reduction of nitrogen oxides when the diesel engine is operating in stoichiometric or rich exhaust conditions.

8. The exhaust system of claim 7, wherein the upstream treatment housing is positioned in close proximity to an outlet of a turbine to prevent a loss in an exhaust gas temperature as the exhaust gas passes from the outlet of the turbine to an inlet of the upstream treatment housing.

9. The exhaust system of claim 8, wherein the quantity of the three-way catalyst of the first dual functionality catalyst is smaller than the quantity of the three-way catalyst of the second functionality catalyst.

10. The exhaust system of claim 8, wherein the quantity of the diesel oxidation catalyst of the first dual functionality catalyst is smaller than the quantity of the diesel oxidation catalyst of the second functionality catalyst.

11. The exhaust system of claim 8, wherein the main exhaust gas system includes a diesel particulate filter.

12. An exhaust system for the treatment of an exhaust gas generated during the operation of a diesel engine, the exhaust system comprising:
a turbine having an inlet and an outlet, the inlet configured to receive the exhaust gas, the exhaust gas exiting the outlet at a first temperature;
an upstream treatment housing operably connected to the outlet of the turbine, the upstream treatment housing having a first dual functionality catalyst comprising a first three way catalyst and a first diesel oxidation catalyst, the first three way catalyst having a formulation configured for the reduction of nitrogen oxides in the exhaust gas, the first diesel oxidation catalyst configured to oxidize hydrocarbons and carbon monoxide in the exhaust gas, the upstream treatment housing being positioned in the exhaust system to receive exhaust gas at a second temperature that is within at least approximately 5 degrees Celsius of the first temperature; and
a main exhaust gas treatment system positioned downstream of the upstream treatment housing, the main exhaust gas treatment system having at a housing containing a second dual functionality catalyst, the second dual functionality catalyst comprising: (1) a second diesel oxidation catalyst configured to oxidize hydrocarbons and carbon monoxide in the exhaust gas; and (2) a second three-way catalyst formulation configured for the reduction of nitrogen oxides in the exhaust gas.

13. The exhaust system of claim 12, wherein a formulation of the first dual functionality catalyst is different than a formulation of the second dual functionality catalyst.

14. The exhaust system of claim 12, wherein the quantity of the first three-way catalyst of the first dual functionality catalyst is smaller than the quantity of the second three-way catalyst of the second dual functionality catalyst.

15. The exhaust system of claim 12, wherein the quantity of the first diesel oxidation catalyst of the first dual functionality catalyst is smaller than the quantity of the second oxidation catalyst of the second dual functionality catalyst.
